(19) United States
(12) Patent Application Publication
(10) Pub. No.: US 2026/0056357 A1
(43) Pub. Date: Feb. 26, 2026

(54) POLARIZATION CONTROL FOR UNCONSTRAINED BEAM PROFILES

(71) Applicant: Quantinuum LLC, Broomfield, CO (US)

(72) Inventors: Adam Jay OLLANIK, Boulder, CO (US); David M. GAUDIOSI, Loveland, CO (US); Rezlind BUSHATI, Rockville, MD (US)

(21) Appl. No.: 19/276,078

(22) Filed: Jul. 22, 2025

Related U.S. Application Data
(60) Provisional application No. 63/685,386, filed on Aug. 21, 2024.

(51) Int. Cl. G02B 5/30; G02B 27/28

(52) U.S. Cl. CPC G02B 5/3083; G02B 27/286

(57) ABSTRACT

A property of a waveplate at a plurality of locations across the waveplate is defined by, for each location, obtaining an expected angle of incidence of an intended incident optical beam at the respective location, and based at least in part on the expected angle of incidence, a goal output polarization for the waveplate, and at least one material property for a material of the waveplate, determining the property of the waveplate at the respective location. A representation of the property of the waveplate for each of the plurality of locations is provided. The waveplate is configured to modify a polarization of the intended incident optical beam that interacts with the waveplate to provide an output optical beam characterized by a goal output polarization via interaction of the intended incident optical beam with the waveplate based at least in part on the property of the waveplate.

### CROSS-REFERENCE TO RELATED APPLICATION(S)

This application claims priority to U.S. Application No. 63/685,386, filed Aug. 21, 2024, the content of which is incorporated herein by reference in its entirety.

### TECHNICAL FIELD

Various embodiments relate to controlling polarization of an optical beam having an unconstrained beam profile. Various embodiments relate to waveplates and corresponding methods and systems configured for controlling polarization for diverging or converging optical beams.

### BACKGROUND

In order to provide high-fidelity polarization control, conventional waveplates generally require that the incident light be provided to the waveplate as a collimated beam. The collimation of the incident beam results in the angle of interaction of the incident beam, with respect to the waveplate, to be consistent across the beam profile. However, in some instances, such as an array of beams provided via a fiber array or a PIC output array, it may be difficult to provide collimated beams to the waveplate. For conventional waveplates, this may result in polarization purity in the resulting beam that is too low for the intended application. Through applied effort, ingenuity, and innovation many deficiencies of conventional waveplates have been solved by developing solutions that are structured in accordance with the embodiments of the present invention, many examples of which are described in detail herein.

### BRIEF SUMMARY OF EXAMPLE EMBODIMENTS

Example embodiments provide waveplates, methods for designing and/or fabricating waveplates, optical assemblies and systems including waveplates, and/or the like, where the waveplates are configured to control polarization of an incident optical beam that is not collimated. For example, the waveplates of various embodiments are configured to provide an output optical beam having a goal polarization in response to an incident optical beam that is a diverging optical beam or a converging optical beam being incident on the waveplate.

For example, the waveplate may be designed based on respective expected angles of incidence of an intended incident optical beam at a plurality of locations across the waveplate. A property of the waveplate at the respective locations of the plurality of locations is then determined, defined, and/or set based on the respective expected angles of incidence for the respective locations.

For example, when the waveplate includes one or more base material layers of a birefringent material or comprising a birefringent film, the property may be the thickness of the birefringent material or birefringent film. For example, in some embodiments, the waveplate comprises a base material layer comprising a birefringent material or a birefringent film and the thickness of the base material layer or the birefringent film may be non-uniform and/or location dependent across the waveplate.

In another example, the waveplate may be a metasurface comprising a plurality of features disposed within respective unit cells of the metasurface. The features may be pillars or protrusions extending out from a base material layer or holes or recesses extending into the base material layer. One or more dimensions of the respective features, shapes of the respective features, orientation of the respective features, and/or positions of the respective locations within the respective unit cells at which respective features are disposed may be non-uniform across the waveplate.

Waveplates of various embodiments may be incorporated into various optical assemblies and such optical assemblies may be incorporated into various beam paths of various systems.

According to a first aspect, a waveplate is provided. In an example embodiment, the waveplate includes one or more base material layers. The waveplate is characterized by at least one property and the at least one property is location dependent such that the at least one property is non-uniform across the waveplate. The waveplate is configured to modify or control a polarization of an optical beam that interacts with the waveplate via the at least one property.

In an example embodiment, the one or more base material layers include a birefringent film and the at least one property is a thickness of the birefringent film.

In an example embodiment, the thickness of the birefringent film is smooth across the waveplate/base material layer.

In an example embodiment, waveplate further comprises a plurality of features each disposed at a respective location, each feature is one of a pillar/protrusion extending out from a surface defined by the one or more base material layers or a hole/recess extending into the surface defined by the one or more base material layers and the at least one property is at least one of (a) at least one dimension of the feature, (b) a shape of the feature disposed, (c) an orientation of the feature, or (d) a position of the respective location of the feature within a unit cell defined on the surface defined by the one or more base material layers.

In an example embodiment, a plurality of unit cells are defined across a surface defined by the one or more base material layers, the waveplate further comprises a plurality of features disposed at respective locations within respective unit cells of the plurality of unit cells, each feature of the plurality of features is one of a pillar/protrusion extending out from the surface defined by the one or more base material layers or a hole/recess extending into the surface defined by the one or more base material layers, and the at least one property is at least one of (a) respective dimensions of the plurality of features, (b) respective shapes of the plurality of features, (c) respective orientations of the plurality of features, or (d) positions of the respective locations of the plurality of features within the respective unit cells.

In an example embodiment, the location dependence of the at least one property corresponds to or is defined by respective expected angles of incidence of an optical beam interacting with the waveplate.

According to another aspect a method of designing a waveplate is provided. In an example embodiment, the method includes defining at least one property of a waveplate at a plurality of locations across the waveplate. Defining the at least one property of the waveplate at a respective location of the plurality of locations includes obtaining an expected angle of incidence of an intended incident optical beam at the respective location, and based at least in part on the expected angle of incidence, a goal output polarization for the waveplate, and at least one material property for a material of the waveplate, determining the at least one property of the waveplate at the respective location. The method further includes providing a representation of the at least one property of the waveplate for each of the plurality of locations. The waveplate is configured to modify a polarization of the intended incident optical beam that interacts with the waveplate to the goal output polarization via interaction of the intended incident optical beam with the waveplate based at least in part on the at least one property of the waveplate at respective locations of the plurality of locations.

In an example embodiment, the at least one property is location dependent such that the at least one property is non-uniform across the plurality of locations.

In an example embodiment, the waveplate is fabricable based at least in part on the representation of the at least one property of the waveplate for each of the plurality of locations to provide the waveplate characterized by the at least one property at the respective locations of the plurality of locations.

In an example embodiment, the method further includes obtaining an expected angle of divergence or convergence of an intended incident optical beam; and obtaining an set distance between a source of the intended incident optical beam and a waveplate, wherein obtaining the expected angle of incidence of the intended incident optical beam at the respective location comprises determining the expected angle of incident of the intended incident optical beam at the respective location based at least in part on the expected angle of divergence or convergence of the intended incident optical beam and the set distance between the source of the intended incident optical beam and the waveplate.

In an example embodiment, the expected angle of divergence or convergence of the intended incident optical beam is determined via at least one of calibration, experimentation, or design.

In an example embodiment, the waveplate comprises a base material layer comprising a birefringent film and the at least one property is a thickness of the birefringent film.

In an example embodiment, a plurality of unit cells are defined across the waveplate and each respective location of the plurality of locations is disposed within a respective unit cell of the plurality of unit cells, the waveplate comprises a plurality of features each disposed at the respective locations, each feature of the plurality of features is one of a pillar/protrusion extending out from a surface of a base material layer of the waveplate or a hole/recess extending into the surface of the base material layer of the waveplate, and the at least one property is at least one of (a) respective dimensions of the plurality of features, (b) respective shapes of the plurality of features, (c) respective orientations of the plurality of features, or (d) respective positions of the respective locations of the plurality of features within the respective unit cells.

According to another aspect an optical assembly is provided. In an example embodiment, the optical assembly includes an incident optical beam source configured to provide one or more incident optical beams for interacting with a waveplate; and the waveplate. The waveplate is configured to provide one or more respective output optical beams each characterized by a respective goal output polarization in response to an incident optical beam of the one or more incident optical beams interacting with the waveplate. The waveplate includes one or more base material layers. The waveplate is characterized by at least one property. The at least one property is location dependent such that the at least one property is non-uniform across the waveplate. The at least one property affects a polarization of the respective output optical beam.

In an example embodiment, the one or more base material layers include a birefringent film and the at least one property is a thickness of the birefringent film.

In an example embodiment, the thickness of the birefringent film is smooth across the one or more base material layers.

In an example embodiment, wherein the wave plate comprises a feature, the feature is one of a pillar/protrusion extending out from a surface defined by the one or more base material layers or a hole/recess extending into the surface defined by the one or more base material layers, and the at least one property is at least one of (a) at least one dimension the feature, (b) a shape of the feature, (c) an orientation of the feature, or (d) a position of a respective location of the feature within a unit cell one surface defined by at least one of the one or more base material layers.

In an example embodiment, a plurality of unit cells are defined across a surface defined by at least one of the one or more base material layers, the waveplate further comprises a plurality of features disposed at respective locations within respective unit cells of the plurality of unit cells, each feature of the plurality of features is one of a pillar/protrusion extending out from the surface or a hole/recess extending into the surface, and the at least one property is at least one of (a) respective dimensions of the plurality of features, (b) respective shapes of the plurality of features, (c) respective orientations of the plurality of features, or (d) respective positions of the respective locations of the plurality of features within the respective unit cells.

In an example embodiment, the location dependence of the at least one property corresponds to or is defined by respective expected angles of incidence of an optical beam interacting with the waveplate.

In an example embodiment, the incident optical beam source is configured to provide the one or more incident optical beams such that the one or more incident optical beams are characterized by an expected angle of divergence or convergence and the incident optical beam source and the waveplate are secured with respect to one another such that the incident optical beam source and the waveplate are separated by an set distance, and the respective expected angles of incidence at respective locations across the waveplate are determined based at least in part on the expected angle of divergence or convergence and the set distance.

In an example embodiment, the optical assembly is part of a beam path system of a quantum or atomic system.

According to another aspect, a quantum or atomic system is provided. In an example embodiment, the system includes a confinement apparatus defining at least one target location and configured to confine one or more quantum or atomic objects; and one or more beam path systems. At least one of the one or more beam path systems includes an optical assembly that is configured to provide a respective output optical beam to the at least one target location for interaction with at least one of the one or more quantum or atomic objects confined at the target location. The optical assembly includes a waveplate comprising one or more base material layers, wherein the waveplate is characterized by at least one property and the at least one property is location dependent such that the at least one property is non-uniform across the waveplate, and the at least one property affects a polarization of the respective output optical beam.

In an example embodiment, the waveplate includes one or more base material layers and the one or more base material layers comprises a birefringent film and the at least one property is a thickness of the birefringent film.

In an example embodiment, the waveplate further comprises one or more features, each feature of the one or more features is a respective one of a (i) protrusion extending out from a surface of a one or more base material layers of the waveguide or (ii) a recess extending into the surface of the one or more base material layers, and the at least one property is at least one of (a) at least one dimension the feature, (b) a shape of the feature, (c) n orientation of the feature, or (d) a position of the feature.

In an example embodiment, a plurality of unit cells are defined across the one or more base material layers, the waveplate further comprises a plurality of features disposed at respective locations within respective unit cells of the plurality of unit cells, each feature of the plurality of features is one of a protrusion extending out from a surface of the one or more base material layers or a recess extending into the surface of the one or more base material layers, and the at least one property is at least one of (a) respective dimensions of the plurality of features, (b) respective shapes of the plurality of features, (c) respective orientations of the plurality of features, or (d) respective positions of the respective locations of the plurality of features within the respective unit cells.

In an example embodiment, the location dependence of the at least one property corresponds to or is defined by respective expected angles of incidence of an optical beam interacting with the waveplate.

In an example embodiment, the at least one of the one or more beam path systems further includes an incident optical beam source that is configured to provide the one or more incident optical beams such that the one or more incident optical beams are characterized by an expected angle of divergence or convergence and the incident optical beam source and the waveplate are secured with respect to one another such that the incident optical beam source and the waveplate are separated by an set distance, and the respective expected angles of incidence at respective locations across the waveplate are determined based at least in part on the expected angle of divergence or convergence and the set distance.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B each provide a respective block diagram of a respective example optical assembly, in accordance with various embodiments.

FIG. 2 provides a schematic diagram illustrating the change in angle of incidence of a diverging optical beam at different locations across the waveplate, in accordance with an example embodiment.

FIG. 3 provides a schematic diagram of a waveplate having a base material layer comprising a birefringent film with a non-uniform thickness, in accordance with an example embodiment.

FIG. 4A provides a sideview of an example waveplate that is a metasurface comprising a plurality of features where one or more properties of the features vary across the waveplate, in accordance with an example embodiment.

FIG. 4B provides a top view of the example waveplate illustrated in FIG. 4A.

FIG. 5 provides a flowchart illustrating various processes and/or procedures for designing and/or fabricating a waveplate, in accordance with an example embodiment.

FIG. 6 provides a flowchart illustrating various processes and/or procedures for defining one or more properties at a respective location of the waveplate, in accordance with an example embodiment.

FIG. 7 provides a block diagram of an example quantum computing system, in accordance with an example embodiment.

FIG. 8 provides a schematic diagram of an example controller of a quantum computer comprising a confinement apparatus configured for confining quantum objects therein, in accordance with an example embodiment.

FIG. 9 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

Waveplates are optical elements configured to control polarization of an optical beam. For example, in response to an incident optical beam being incident on the waveplate, an output optical beam having a goal polarization is provided. However, the waveplate performance depends on the angle of incidence of the incident optical beam.

Conventional waveplates generally require the incident optical beam to be collimated when the incident optical beam is incident on the waveplate. The collimation of the incident beam results in the angle of incidence of the incident optical beam, with respect to the waveplate, to be consistent across the beam profile. When the incident optical beam is not collimated, conventional waveplates tend to provide only low-fidelity polarization control.

In some instances, such as an array of beams provided via a fiber array or a PIC output array, for example, it may be difficult to provide collimated beams to the waveplate. For conventional waveplates, this may result in polarization purity in the output optical beam that is too low for the intended application. Therefore, technical problems exist regarding providing waveplates that provide high-fidelity polarization control for incident optical beams that are diverging or converging.

Various embodiments provide technical solutions to these technical problems. In various embodiments, at least one property of a waveplate is defined at a plurality of locations across the waveplate. The at least one property at a respective location is determined based at least in part on the expected angle of incidence of an intended incident optical beam. For example, the expected angle of incidence at a respective location on the waveplate of an intended incident optical beam for a particular incident optical beam source is determined and the at least one property is determined based on the expected angle of incidence at the respective location.

In some embodiments, the waveplate includes a base material layer that is a birefringent film. The at least one property is a thickness of the birefringent film. For example, the respective thicknesses of the birefringent film at a plurality of locations across the waveplate are determined based on the expected angles of incidence at the plurality of locations.

In some embodiments, the waveplate is a metasurface comprising a plurality of features where each feature is a pillar/protrusion extending from a surface of the base material layer or a hole/recess extending into the surface of the base material layer. A height that a feature extends out from or into the surface of the base material layer, a cross-sectional shape of a feature (in a cross-section taken in a plane parallel to the surface of the base material layer), one or more dimensions of a cross-section (taken in a plane parallel to the surface of the base material layer) of the feature, an orientation of the feature, and/or a position of the feature within a unit cell defined on the waveplate is determined based on an expected angle of incidence at the location of the feature and/or within the unit cell that the feature is disposed within.

In a given optical assembly, an intended incident optical beam source may provide or be configured/designed to provide an expected incident optical beam characterized by a non-zero angle of divergence or convergence. By designing and fabricating the waveplate of the optical assembly to provide an output optical beam having a goal polarization in response to the expected incident optical beam (characterized by the non-zero angle of divergence or convergence) based on the expected angles of incidence of the expected incident optical beam at a plurality of locations across the waveplate, the waveplate is able to have a non-collimated beam incident thereon and provide an output optical beam with high polarization purity. In other words, the non-uniformity of the at least one property of the waveplate at the plurality of locations across the waveplate enables high-fidelity polarization control for an optical assembly without requiring collimation of the incident optical beam.

Such optical assemblies may be included in various systems. For example, such optical assemblies may be part of beam path systems of a quantum and/or atomic system configured to provide optical beams for interaction with confined or trapped quantum and/or atomic objects. For example, the high-fidelity polarization control provided by the optical assembly may enable high-fidelity interactions with quantum and/or atomic objects of a quantum and/or atomic systems such as quantum charge-coupled device (QCCD)-based quantum computers.

Therefore, various embodiments provide technical improvements to technical fields such as waveplates, optical assemblies including waveplates, systems including waveplates, quantum and/or atomic systems where polarization of optical beams used to interact with quantum and/or atomic objects is important, and quantum computers that use optical beams to interact with qubits.

### Example Optical Assemblies

In various embodiments, an optical assembly includes a waveplate and an optical component comprising at least one expected incident optical beam source. For example, the optical component may be a fiber optic cable and the incident optical beam source may be an output end of the fiber optic cable. In some embodiments, the fiber optic cable is part of an array of fiber optic cables each configured to provide a respective expected incident optical beam. In another example, the optical component may be a photonic integrated circuit (PIC) and the expected incident optical beam source(s) may be respective output ends of waveguides of the PIC. In another example, the optical component may be an optical path defined by a sequence of free space optical elements (e.g., lenses, mirrors, and/or the like) and the expected incident optical beam source may be the optical element of the sequence of free space optical elements that immediately precedes the waveplate.

In some embodiments, the waveplate is configured to receive incident optical beams from multiple expected incident optical beam sources. In other embodiments, the waveplate is configured to receive an incident optical beam from only one expected incident optical beam source. For example, if the optical assembly includes an array of expected incident optical beam source, the optical assembly may also include an array of waveplates with each waveplate corresponding to a respective expected incident optical beam source.

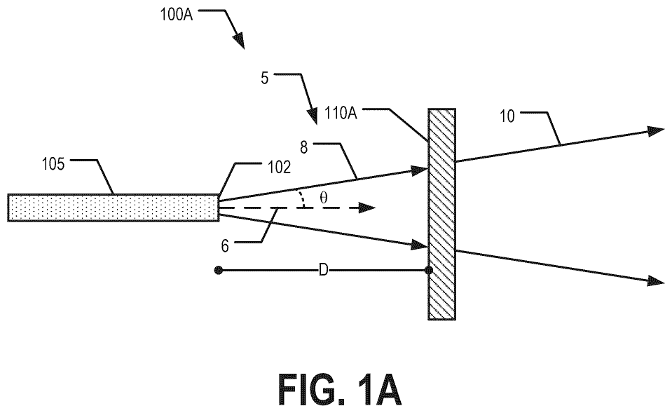

FIG. 1A illustrates an example optical assembly 100A. The optical assembly 100A includes an optical component in the form of an optical fiber 105 and a waveplate 110A. The optical fiber 105 includes an incident optical beam source 102 in the form of the tip/end of the optical fiber 105. For example, the incident optical beam source 102 (e.g., the tip/end of the optical fiber 105) is the last optical element that the incident optical beam 5 interacts with prior to interacting with the waveplate 110A.

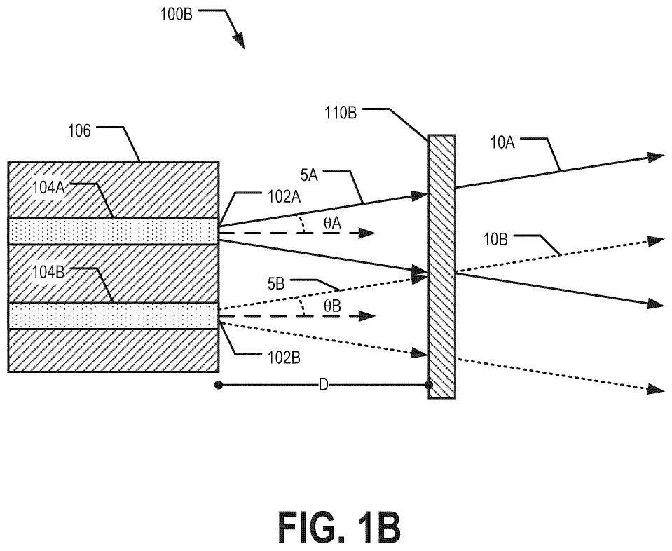

The incident optical beam 5 has an angle of divergence or convergence θ. As illustrated in FIGS. 1A, 1B, and 2, the angle of divergence or convergence θ of an incident optical beam is the angle between the direction of propagation and/or optical axis 6 of the incident optical beam (e.g., the direction in which the k vector for the incident optical beam points) and the radius of the full width half maximum (FWHM) 8 of the incident optical beam 5 or where the intensity of the beam is 1/e² the maximum intensity of the incident optical beam 5. The angle of divergence or convergence may be defined as the angle between opposing edges of the FWHM or the 1/e² of the maximum intensity radius (e.g., equal to two times the illustrated θ when the incident optical beam is symmetric around the direction of propagation and/or optical axis 6) and/or the like in various other embodiments. The angle of divergence or convergence θ may be determined via calibration and/or empirical means (e.g., measurement) or determined based on a design of the tip/end of the optical fiber 105, optical mode of the expected incident optical beam 5, and/or the like.

The waveplate 110A is secured a set distance D from the incident optical beam source 102. The set distance D may be determined based on various preferences, design constraints, and/or space constraints for the optical assembly 100A.

When the incident optical beam 5 is incident on the waveplate 110A, the waveplate provides an output optical beam 10 having a goal polarization. For example, the incident optical beam 5 may have an arbitrary polarization or a first polarization that is easy to provide via the optical fiber 105 or other optical elements of the optical assembly 100A or a beam path system of which the optical assembly 100A is a part. The incident optical beam 5 interacts with the waveplate 110A, the waveplate 110A controls and/or modifies the polarization of the incident optical beam 5, and the resulting output optical beam 10 has a goal polarization.

FIG. 1B illustrates another optical assembly 100B. The optical assembly 100B includes an optical component in the form of a photonic integrated circuit (PIC) 106 and a waveplate 110B. The PIC includes one or more waveguides 104 (e.g., 104A, 104B). The PIC 106 is illustrated as including two incident optical beam sources 102A, 102B in the form of the outputs of waveguides 104A, 104B. For example, the incident optical beam sources 102A, 102B (e.g., the outputs of the waveguides 104A, 140B) are the last optical element that the respective incident optical beams 5A, 5B interact with prior to interacting with the waveplate 110B.

Each incident optical beam 5A, 5B has a respective angle of divergence or convergence θA, θB. The angles of divergence or convergence θA, θB of the incident optical beams 5A, 5B may be the same or may be different from one another. The angles of divergence or convergence θA, θB may be determined via calibration and/or empirical means (e.g., measurement) or determined based on a design of the respective outputs of the waveguides 104A, 104B, optical mode of the expected incident optical beam 5A, 5B, and/or the like.

The waveplate 110B is secured a set distance D from the incident optical beam sources 102. The set distance D may be determined based on various preferences, design constraints, and/or space constraints for the optical assembly 100B.

When an incident optical beam 5A, 5B is incident on the waveplate 110B, the waveplate provides a corresponding output optical beam 10A, 10B having a respective goal polarization. For example, the incident optical beam 5A, 5B may have an arbitrary polarization or a first polarization that is easy to provide via the respective waveguide 104A, 140B or other optical elements of the optical assembly 100B or a beam path system of which the optical assembly 100B is a part. The incident optical beam 5A, 5B interacts with the waveplate 110B, the waveplate 110B controls and/or modifies the polarization of the incident optical beam 5A, 5B, and the resulting output optical beam 10A, 10B has a goal polarization.

In some embodiments, the incident optical beams 5A, 5B may have a same polarization. In some embodiments, the incident optical beams 5A, 5B have different polarizations. In some embodiments, the first output optical beam 10A, provided responsive to interaction of the first incident optical beam 5A with the waveplate 110B, has a first goal polarization and the second output optical beam 10B, provided responsive to interaction of the second incident optical beam 5B with the waveplate 110B, has a second goal polarization. The first goal polarization and the second goal polarization may be the same or different, in various embodiments. For example, the waveplate 110B may be used to control the respective polarizations of a plurality of output optical beams simultaneously and individually.

FIG. 2 illustrates how the angle of incidence φ of the incident optical beam changes across the waveplate 110 as a result of the angle of divergence or convergence θ of the incident optical beam 5. As used herein, the angle of incidence φ is an angle between the local direction of propagation of a portion of the incident optical beam 5 as the portion of the incident optical beam 5 is incident on an upstream surface 112A of the waveplate 110 and a plane defined at least in part by the upstream surface 112A, a midplane 118, and/or the downstream surface 112B of the waveplate 110. For example, the angle of incidence φ is an angle between the local direction of propagation of a portion of the incident optical beam 5 as the portion of the incident optical beam 5 is incident on an upstream surface 112A of the waveplate 110 and a plane that is parallel to the upstream surface 112A, a midplane 118 of the waveplate 110, and/or the downstream surface 112B of the waveplate 110.

As shown in FIG. 2, at a first location 114A of the waveplate 110, a portion of the incident optical beam is incident on the upstream surface 112A of the waveplate 110 with a first angle of incidence φA. At a second location 114B of the waveplate 110, a portion of the incident optical beam is incident on the upstream surface 112A of the waveplate 110 with a second angle of incidence φB. At a third location 114C of the waveplate 110, a portion of the incident optical beam is incident on the upstream surface 112A of the waveplate 110 with a third angle of incidence φC. The illustrated first angle of incidence φA, second angle of incidence φB, third angle of incidence φC are different from one another. In order to accommodate the difference in the first angle of incidence φA, the second angle of incidence φB, and third angle of incidence φC at least one property of the waveplate 110 at the first location 114A is different from the at least one property at the second location 114B and from the at least one property at the third location 114C.

In various embodiments, the waveplate is characterized by at least one property that is non-uniform across the waveplate. For example, the waveplate is characterized via at least one property that is location dependent. In other words, the at least one property is different at different locations across the waveplate. The wave plate is configured to modify or control a polarization of an incident optical beam that interacts with the waveplate via the at least one property. For example, the location dependence of the at least one property of the waveplate may correspond to the differences in the angle of incidence φ of an expected incident optical beam across the waveplate.

In various embodiments, symmetry of the incident optical beam may result in some locations of a plurality of locations of the waveplate having the same angle of incidence. For example, one or more sets of locations of the plurality of locations of the waveplate may have the same angle of incidence. Each location of such a set of locations may have the same at least on property, in some embodiments.

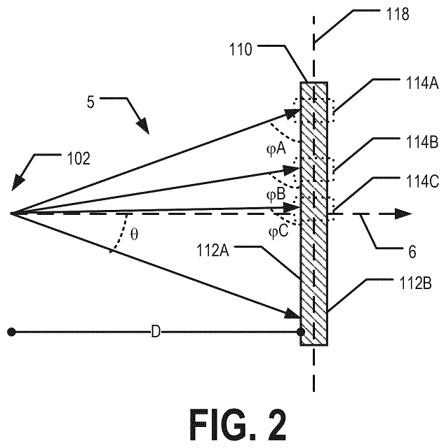

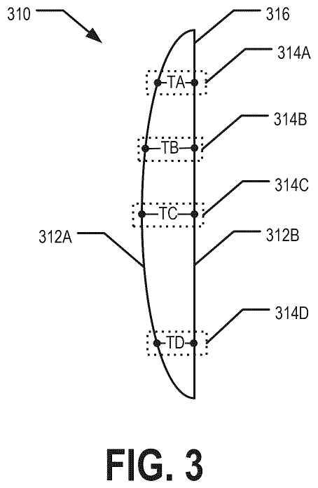

In some embodiments, the at least one property is a thickness of the base material layer, as illustrated in FIG. 3. In some embodiments, the at least one property characterizes respective features of the waveplate where the features are either pillars/protrusions that extend out from a surface (e.g., the upstream surface 112A or the downstream surface 112B) of a base material layer of the waveplate or holes/recesses that extend into a surface (e.g., the upstream surface 112A or the downstream surface 112B) of the base material layer of the waveplate, as shown in FIGS. 4A and 4B.

FIG. 3 illustrates an example waveplate 310 comprising a base material layer 316. The base material layer 316 comprises a birefringent material. A birefringent material is a material having a refractive index that depends on the polarization and propagation direction of light. The effect of the base material layer 316 on the polarization of the incident optical beam as the incident optical beam propagates through the base material layer 316 to form the output optical beam is dependent on an angle of incidence of the incident optical beam and the thickness of the base material layer 316. As used herein, the thickness of the base material layer 316 at a respective location is the distance between the upstream surface 312A and the downstream surface 312B at the respective location.

As shown in FIG. 3, at a first location 314A, the base material layer 316 has a first thickness TA, at a second location 314B, the base material layer 316 has as second thickness TB, and, at a third location 314C, the base material layer 316 has a third thickness TC. The first thickness TA, second thickness TB, and third thickness TC are different from one another. For example, similar to as shown in FIG. 2, the angle of incidence φ of the incident optical beam at the first location 314A, second location 314B, and third location 314C are different from one another and therefore the property of the waveplate 310 (the thickness of the base material layer 316) is different at each of the first location 314A, second location 314B, and third location 314C.

In some embodiments, due to symmetry of the incident optical beam 5, the angle of incidence at a location (e.g., the first location 314A) is the same as at another location (e.g., the fourth location 314D). The property of the waveplate at the first location 314A (i.e., the first thickness TA) is equal to the property of the waveplate at the fourth location 314D (i.e., the fourth thickness TD) as a result of the equal angles of incidence at the first location 314A and the fourth location 314D.

In various embodiments, the waveplate 310 is fabricated such that the thickness of the base material layer 316 changes smoothly across the base material layer 316. For example, the thickness of the base material layer 316 is a smooth function across the base material layer 316. For example, the thickness at a finite number of locations may be determined during a design process and during a fabrication process the base material layer 316 may be fabricated and/or processed such that the upstream surface 312A and/or downstream surface 312B are smooth. For example, the waveplate 310 may be a continuous base material layer characterized by a non-uniform, but smoothly varying thickness. In various embodiments, the thickness of the base material layer varies or changes smoothly when the thickness of the base material layer as a function of position on the waveplate 310 is differentiable; is twice differentiable; has continuous derivatives/gradients of the first order, second order, and/or higher orders; and/or the like. For example, the thickness of the continuous base material layer may not include any discontinuities. While the illustrated waveplate 310 is a standalone optical element, in some embodiments, the waveplate 310 is disposed on a substrate.

FIG. 4A illustrates an example side view of a waveplate 410 and FIG. 4B illustrates a top view of the example waveplate 410 where the waveplate 410 is a metasurface. In general, a metasurface comprises a plurality and/or array of features that have at least one dimension that is smaller than a wavelength that characterizes the incident optical beam 5. The waveplate 410 comprises a base material layer 416 and a plurality of features 418 (e.g., 418A-418G). In various embodiments, the features 418 are either pillars/protrusions that extend out from one of the upstream surface 412A or the downstream surface 412B of the base material layer 416 or holes/recesses that extend into one of the upstream surface 412A or the downstream surface 412B of the base material layer 416. In some embodiments, the base material layer 416 is a birefringent film, a translucent material with respect to a wavelength that characterizes the expected incident optical beam, a reflective material with respect to a wavelength that characterizes the expected incident optical beam, and/or the like. For example, the base material layer 416 may be a birefringent film (of uniform thickness) configured to control the polarization of a collimated beam and the one or more features 418 may be configured to enable the resulting waveplate 410 to control the polarization of an expected incident optical beam 5 that is a non-collimated beam (e.g., that is a diverging beam, converging beam, or other non-collimated beam). For example, the waveplate 410 may control the polarization of an expected incident optical beam 5 that is a non-collimated beam (e.g., that is a diverging beam, converging beam, or other non-collimated beam) with high-fidelity so as to provide an output optical beam with high polarization purity.

While the illustrated waveplate 410 is a standalone optical element, in some embodiments, the base material layer 416 is disposed on a substrate. In some embodiments, the features are protrusions that are regions of the base material layer that extend outward from a surface of the base material layer. For example, the features may be formed by etching the base material layer to provide protrusions extending therefrom.

In various embodiments, an array or grid 420 of unit cells 422 (e.g., 422A, . . . , 422I, . . . , 422N) is (virtually) defined on a surface of the base material layer 416. The surface may be either the upstream surface 412A or the downstream surface 412B. Each location 414 (e.g., 414A-414G, . . . , 414I, . . . , 414N) of the plurality of locations is disposed within a respective unit cell 422.

In various embodiments, the at least one property of the waveplate 410 at a respective location includes a characterization of a shape, size, orientation, or position of a feature 418 within a respective unit cell 422. For example, the at least one property of the waveplate at a respective location may include a characterization of a shape of a feature disposed at the respective location. For example, the shape of the feature is a geometric shape of the feature in a cross-section taken parallel to the surface from or into which the feature extends. In various embodiments, the shape of a feature may be a circle, an ellipse, a polygon (e.g., triangle, quadrilateral, square, rectangle, diamond, pentagon, hexagon, heptagon, octagon, and/or the like), an irregular shape, and/or the like.

For example, the at least one property of the waveplate 410 at a respective location 414 may include one or more dimensions of the feature disposed at the respective location 414. For example, when the shape of the feature is a circle, the one or more dimensions may include a radius or diameter of the circle. When the shape of the feature is an ellipse, the one or more dimensions may include a major axis and a minor axis. When the shape of the feature is a polygon, the one or more dimensions may include a length of one or more sides of the polygon.

In some embodiments, the one or more dimensions may include a height that the feature extends out from the surface (e.g., the upstream surface 412A or the downstream surface 412B or a depth into the surface (e.g., the upstream surface 412A or the downstream surface 412B) that the feature extends. For example, the second feature 418B located at a second location 414B extends out from the upstream surface 412A a height HB and the third feature 418C located at a third location 414C extends out from the upstream surface 412A a height HC. The height HB is different from the height HC to accommodate the difference in the angles of incidence φ at the second location 414B and the third location 414C.

In some embodiments, the at least one property of the waveplate 410 at a respective location 414 includes the orientation of the feature disposed at the respective location 414. For example, when the shape of the feature is an ellipse, the orientation of the feature may be provided as an angle between the major or minor axis of the ellipse and a reference direction along the surface (e.g., the upstream surface 412A or the downstream surface 412B). In general, the orientation of the feature may be provided as angle between a particular axis of the feature and a reference direction along the surface (e.g., the upstream surface 412A or the downstream surface 412B).

In some embodiments, the at least one property of the waveplate 410 at a respective location 414 includes a position of the respective location within the corresponding unit cell. In some embodiments, the respective location 414 is the center point of the corresponding unit cell 422. For example, the location 414I is the center point of unit cell 422I. In some embodiments, when the at least one property of the waveplate 410 at the respective location does not explicitly include a position of the respective location 414 within the respective unit cell 422, the position is the center point of the unit cell 422. In some embodiments, the at least one property of the waveplate 410 at the respective location indicates the offset of the respective location 414 from a corner of the corresponding unit cell 422, the offset of the respective location 414 from a center point of the corresponding unit cell 422, and/or another indication of a position within the corresponding unit cell 422.

As noted above, the at least one property of the waveplate at a respective location of a plurality of locations across the waveplate corresponds to an expected angle of incidence φ of an incident optical beam (provided by an incident optical beam source 102 of the optical assembly including the waveplate). For example, the at least one property of the waveplate at the respective location is configured to cause a portion of an incident optical beam incident at the respective location with the expected angle of incidence φ to result in a corresponding portion of an output optical beam having a goal polarization. For example, the at least one property effects a polarization of an output optical beam provided in response to an incident optical beam interacting with the waveplate.

### Example Method of Designing and/or Fabricating a Waveplate or an Optical Assembly

In various embodiments, a waveplate for inclusion in an optical assembly may be designed and fabricated and the optical assembly may be assembled so as to include an optical component that includes an incident optical beam source and the waveplate. The incident optical beam source is an optical element that an incident optical beam interacts with immediately preceding interaction with the waveplate. For example, the incident optical beam source may be a tip of an optical fiber; an output of a waveguide of a PIC; a lens, metasurface, grating, coupler, or other optical element secured to the tip of an optical fiber or output of a waveguide; or a free space optical element.

The waveplate is designed to provide an output optical beam having a goal polarization in response to an incident optical beam provided by the incident optical beam source interacting with the waveplate. In various embodiments, an angle of divergence or convergence that characterizes an incident optical beam provided by the incident optical beam source may be known or determined. For example, the angle of divergence or convergence that characterizes an incident optical beam provided by the incident optical beam source may be determined via calibration or empirical means (e.g., measurement) or based on the design of the incident optical beam source. The angle of divergence or convergence that characterizes an incident optical beam provided by the incident optical beam source is then used to design the waveplate. The waveplate may then be fabricated and the optical assembly may be assembled to include the optical component including the incident optical beam source and the waveplate such that an expected or set distance is disposed between the incident optical beam source and the waveplate.

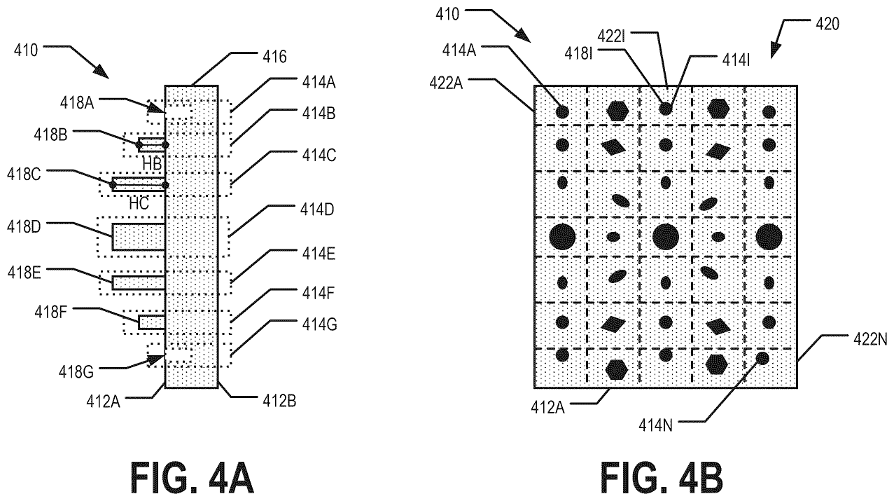

FIG. 5 provides a flowchart illustrating various processes and/or procedures for designing a waveplate for an optical assembly, fabricating the waveplate, and/or assembling the optical assembly, according to various embodiments.

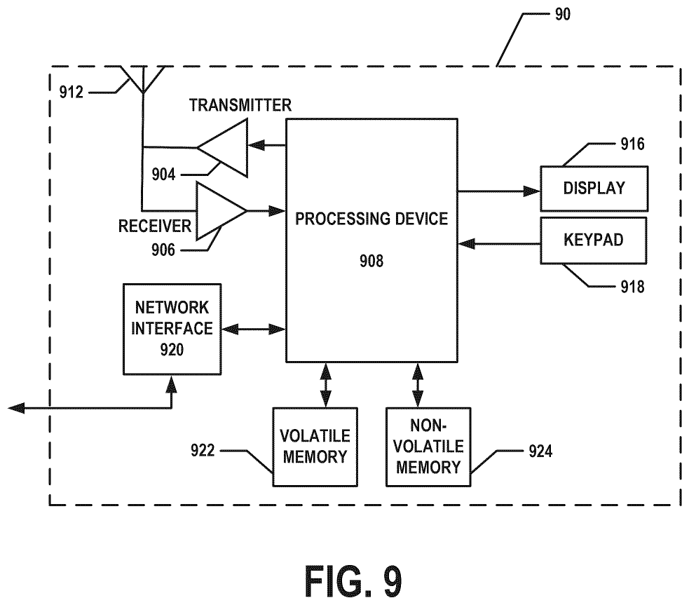

In various embodiments, the steps illustrated in FIG. 5 are performed by a (classical and/or semiconductor-based) computing entity such as computing entity 90 illustrated in FIG. 9. For example, the computing entity 85 may include a processing device 908, (non-transitory) memory (such as volatile memory 922 and/or non-volatile memory 924), communications interfaces such as one or more network interfaces 920 and/or an antenna 912 in communication with the processing device 908 via a transmitter 904 and/or a receiver 906), and/or a user interface including input/output devices such as a display 916 and/or keypad 918.

Starting at step 502 of FIG. 5, the computing entity 90 obtains an expected angle of divergence or convergence φ for an expected incident optical beam 5. In various embodiments, the expected angle of divergence or convergence φ for an expected incident optical beam 5 is determined based on calibration or empirical means (e.g., measurement) of the angle of divergence or convergence φ for an expected incident optical beam 5 or based on design information for the optical assembly, optical component of the optical assembly, and/or the incident optical beam source of the optical assembly.

In an example embodiment, the computing entity 90 obtains the expected angle of divergence or convergence φ of an expected incident optical beam 5 by accessing design information for the incident optical beam source of the optical assembly (possibly stored in memory 922, 924) and determining an expected angle of divergence or convergence φ for an expected incident optical beam 5 based at least in part thereon. In another example, a user may provide an expected angle of divergence or convergence φ for an expected incident optical beam 5 via a user interface (e.g., via an interactive user interface provided via display 916 and via interaction with keypad 918). In another example embodiment, another computing entity may provide (e.g., transmit) the expected angle of divergence or convergence φ for an expected incident optical beam 5 such that the computing entity 90 receives the expected angle of divergence or convergence φ for an expected incident optical beam 5 via network interface 920 or antenna 912 and receiver 906. In another example, the computing entity 90 may cause a measurement of the angle of divergence or convergence of an expected incident optical beam 5 to be performed and receive a result thereof.

At step 504, the computing entity 90 obtains a set distance between the incident optical beam source and the waveplate. In an example embodiment, the computing entity 90 obtains the set distance D by accessing design information for the optical assembly (possibly stored in memory 922, 924). In another example, a user may provide a set distance D for the optical assembly via a user interface (e.g., via an interactive user interface provided via display 916 and via interaction with keypad 918). In another example embodiment, another computing entity may provide (e.g., transmit) the set distance D such that the computing entity 90 receives the set distance D for the optical assembly via network interface 920 or antenna 912 and receiver 906. In various embodiments, the set distance D for the optical assembly is the (intended) distance between the incident optical beam source 102 and the waveplate 110. In various embodiments, the set distance D is determined based on various preferences and/or intended uses of the optical assembly, design constraints, and/or space constraints for the optical assembly 100A.

In some embodiments, the computing entity 90 may further obtain a set angle between the optical axis 6 of the expected incident optical beam 5 and a plane defined at least in part by the upstream surface 112A, a midplane 118, and/or the downstream surface 112B. In various embodiments, the set angle is obtained along with and/or via a same technique as the set distance D. In various embodiments where a set angle is not obtained, the set angle may be assumed to be ninety degrees or another pre-set set angle.

At step 506, the computing entity 90 defines at least one property of the waveplate for each location of a plurality of locations across the waveplate. In various embodiments, the at least one property of the waveplate for a respective location is defined and/or determined based on the angle of incidence of the expected incident optical beam 5 at the respective location. For example, the at least on property at the respective location controls and/or influences how the waveplate affects the polarization of a portion of an optical beam that interacts with the respective location, which is dependent on the angle of incidence or the portion of the optical beam at the respective location.

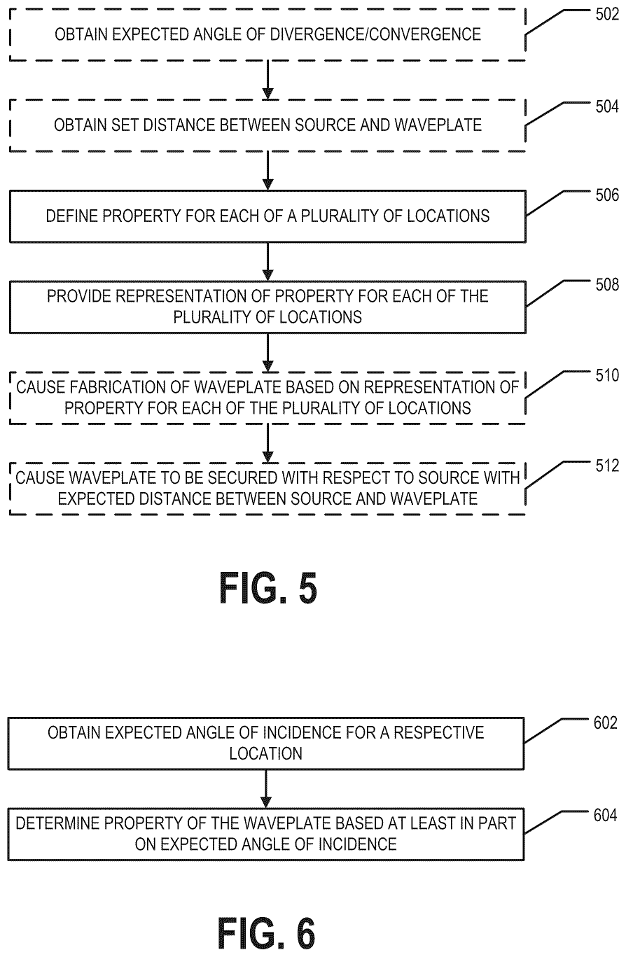

FIG. 6 provides a flowchart illustrating various processes and/or procedures performed by a computing entity 90 to define at least one property of the waveplate at a respective location of a plurality of locations across the waveplate, according to an example embodiment.

Starting at step 602, the computing entity 90 obtains, accesses, and/or determines an expected angle of incidence φ for the respective location. For example, for a respective location of the plurality of locations, the expected angle of incidence φ may be determined based at least in part on the angle of divergence or convergence θ for the expected incident optical beam, the set distance D, and the location of the respective location on the waveplate. For example, a trigonometric function may be used to determine the expected angle of incidence φ at a respective location of the plurality of locations based at least in part on the relative location of the of the respective location with respect to the point where the optical axis 6 of the expected incident optical beam is (expected to be) incident on the waveplate, the set distance D, the angle of divergence or convergence θ, and/or the set angle. For example, the computing entity 90 comprises means, such as processing device 908, memory 922, 924, network interface 920, antenna 912 and receiver 906, a user interface including input/output devices such as display 916 and keypad 918, and/or the like for obtaining, accessing, and/or determining an expected angle of incidence φ for the respective location.

At step 604, the computing entity 90 determines the at least one property of the waveplate for the respective location based at least in part on the expected angle of incidence q for the respective location. For example, the computing entity 90 comprises means, such as processing device 908, memory 922, 924, and/or the like, for determining the at least one property of the waveplate for the respective location based at least in part on the expected angle of incidence φ for the respective location.

For example, in some embodiments, the waveplate is designed to include a base material layer that is formed of and/or includes a birefringent film and/or a birefringent material. The at least one property is the thickness of the birefringent film and/or birefringent material. Based at least in part on the expected angle of incidence at the respective location, a goal output polarization for the waveplate, and at least one material property of the birefringent material (e.g., a material property that characterizes the birefringent properties of the birefringent material), the computing entity 90 determines a thickness of the birefringent film and/or the birefringent material at the respective location. In some embodiments, the plurality of locations are defined as the nodes of a grid (a rectangular grid, a radial grid, and/or the like) across a surface (e.g., the upstream surface or the downstream surface) of the waveplate.

In another example, in some embodiments, the waveplate is a metasurface comprising a plurality of features extending out from or extending into a material base layer. A plurality of unit cells may be (virtually) defined across the surface of the waveplate. For example, a grid (e.g., rectangular grid, radial grid, and/or the like) of unit cells may be defined across a surface (e.g., the upstream surface or the downstream surface) of the waveplate. A respective location is disposed within a corresponding unit cell. In some embodiments, a respective location is a center pint of the corresponding unit cell. In some embodiments, the respective location is either a set position within the corresponding unit cell or a position within the unit cell that is determined as part of determining the at least one property of the waveplate at the respective location.

In various embodiments where the waveplate is a metasurface, the at least one property of the waveplate includes one or more of (a) a shape of a feature configured to be disposed at the respective location, (b) one or more dimensions of the feature configured to be disposed at the respective location (e.g., a height with respect to the surface of the base material layer and/or one or more dimensions of a cross-section of the feature taken in a plane parallel to the surface of the base material layer), (c) an orientation of the feature configured to be disposed at the respective location, or (d) a position of the respective location within the corresponding unit cells. In various embodiments the at least one property is determined based at least in part on the expected angle of incidence at the respective location, a goal output polarization for the waveplate, and at least one material property of the material of the base material layer and/or the material from which the features are to be fabricated. In various embodiments, the at least one property of the waveplate at the respective location is determined by modeling a response of an optical beam interacting with one or more features characterized by one or more properties and optimizing the one or more properties to achieve a desired response. For example, the at least one property of the waveplate at the respective location, characterizing the feature disposed at the respective location and/or a position of the respective location within the corresponding unit cell, may be determined using a technique similar to that disclosed by U.S. Application No. 18,486,262, filed Oct. 13, 2023, and/or by U.S. Application No. 63/623,443, filed Jan. 22, 2024, the contents of which are incorporated herein by reference in their entireties.

The processes and/or procedures illustrated in FIG. 6 may then be repeated (and/or performed in parallel) for each respective location of the plurality of locations.

Returning to FIG. 5, at step 508, the computing entity 90 provides a representation of the at least one property for each of the plurality of locations. In an example embodiment, the computing entity 90 provides the representation of the at least one property for each of the plurality of locations by causing display the representation via display 916. In another example, the computing entity 90 provides the representation of the at least one property for each of the plurality of locations by transmitting (e.g., via network interface 920 and/or via antenna 912 and transmitter 904) the representation of the at least one property for each of the plurality of locations for receipt by another computing entity (e.g., a computing entity configured to control one or more aspects of the fabrication of the waveplate). In another example, the computing entity 90 provides the representation of the at least one property for each of the plurality of locations by storing the representation of the at least one property for each of the plurality of locations in memory (e.g., memory 922, 924).

At step 510, the computing entity 90 may cause the waveplate to be fabricated based on the representation of the at least one property for each of the plurality of locations. For example, in some embodiments, the computing entity 90 controls one or more waveplate fabrication components and/or machines to cause fabrication of the waveplate. In another example, the receipt of the representation of the at least one property for each of the plurality of locations by a fabrication computing entity configured to control one or more aspects of the fabrication of the waveplate may cause the fabrication computing entity to control one or more waveplate fabrication components and/or machines to cause fabrication of the waveplate.

In various embodiments, the waveplate is fabricated to have the at least one property at each of the plurality of locations, in accordance with the representation of the at least one property for each of the plurality of locations.

For example, the waveplate may be fabricated to include a birefringent film having respective thicknesses at the plurality of locations indicated by the representation of the at least one property for each of the plurality of locations. Moreover, the birefringent film may be fabricated to be smooth (e.g., the upstream surface and/or downstream surface is smooth and/or polished) and/or to have a thickness that changes smoothly across the waveplate. For example, the waveplate 310 may be a continuous base material layer characterized by a non-uniform, but smoothly (e.g., is differentiable, is twice differentiable, has continuous derivatives/gradients of the first order, second order, and/or higher orders) varying thickness. For example, the thickness of the continuous base material layer may not include any discontinuities.

In various embodiments, the birefringent film is fabricated by starting with a wafer of the birefringent material or depositing/growing the birefringent film and then processing the birefringent film using ion beam milling/trimming, fluid jet polishing, and/or the like to cause the birefringent film to have, at respective locations, respective thicknesses as indicated by the representation of the at least one property for each of the plurality of locations. The processing of the birefringent film may further cause the surfaces (e.g., upstream surface and/or downstream surface) of the birefringent film to be smooth and/or to cause the thickness of the birefringent film to change smoothly (e.g., have a smooth and continuous gradient). In some but not all embodiments, the birefringent film is disposed on a substrate.

In another example, the waveplate may be fabricated to include a plurality of features disposed at respective locations of base material layer of the waveplate. For example, the plurality of features may be fabricated (e.g., via one or more lithographic processes) on the base material layer such that each feature is characterized by the respective at least one property for the respective location at which the feature is disposed. In an example embodiment, the plurality of features are formed by etching the base material layer to provide a plurality of features as protrusions extending from a surface of the base material layer or as recesses extending into the surface of the base material layer. In some embodiments, the plurality of features are formed by depositing and patterning the features on the surface of the base material. The deposited and patterned features may be formed of the same material as the base material layer or of another material.

In some embodiments, the waveplate includes a base material layer comprising a birefringent material and/or birefringent film having a plurality of features formed thereon (extending from and/or into a surface thereof).

At step 512, the optical assembly is assembled. For example, waveplate is secured with respect to the incident optical beam source such that the set distance D is disposed between the incident optical beam source and the waveplate. For example, the computing entity 90 or the fabrication computing entity that received the representation of the at least one property for each of the plurality of locations provided by the computing entity 90 may control one or more optical assembly assembling components and/or machines to cause the waveplate to be secured into relationship with the incident optical beam source such that the set distance D is disposed between the incident optical beam source and the waveplate. In an example embodiment, the waveplate is secured into relationship with the incident optical beam source such that the optical axis of the expected optical beam source interacts with the waveplate at the set angle.

In various embodiments, the waveplate is aligned with the incident optical beam source using a passive or active alignment process and then secured into relationship with the optical beam source. For example, an active alignment process may be used to determine an alignment of the waveplate with respect to the optical beam source that provides the maximum polarization purity of the output optical beam. In some embodiments, mechanical features or spacers are physically introduced to cause the waveplate to be positioned with the correct standoff in the axial direction (e.g., the set distance D) with respect to the optical beam source. In some embodiments, the waveplate is secured with respect to the optical beam source using a method similar to that disclosed by U.S. Application No. 63/728,915, filed Dec. 6, 2024, the content of which is incorporated herein by reference in its entirety. For example, the optical beam source may be an optical fiber or a waveguide of a photonic integrated circuit (PIC) and the waveplate may be secured to and of the optical fiber and/or a face or facet of the PIC.

### Example System Including Optical Assemblies

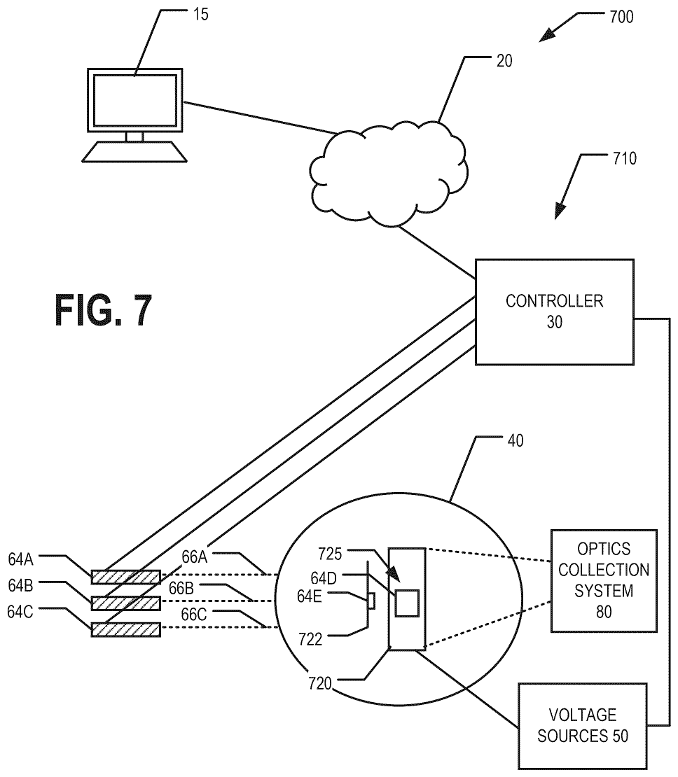

Various embodiments provide systems and/or apparatuses that include optical assemblies that include waveplates configured to provide polarization-controlled output optical beams in response to incident optical beams having unconstrained beam profiles. For example, various embodiments provide systems and/or apparatuses that include optical assemblies that include waveplates configured to provide high-fidelity polarization-controlled output optical beams in response to diverging or converging incident optical beams. For example, optical assemblies of various embodiments may be used to provide optical signals between various components of a system, condition optical signals, and/or the like. For example, an optical assembly may be part of a beam path system configured to provide a respective output optical beam to a target location of the system (e.g., defined by a confinement apparatus configured to confine quantum and/or atomic objects) for interaction with one or more quantum or atomic objects confined at the target location by the confinement apparatus. An example of a system that may include one or more optical assemblies of various embodiments is a quantum computer that uses optical beams, such as laser beams, to perform one or more qubit interactions, sympathetic laser cooling, and/or the like. FIG. 7 illustrates an example quantum charge-coupled device (QCCD)-based quantum computer system 700 that may include optical assemblies of various embodiments.

In various embodiments, the quantum computer system 700 comprises a classical (e.g., semiconductor-based) computing entity 15 and a quantum computer 710. In various embodiments, the quantum computer 710 comprises a controller 30, a cryostat and/or vacuum chamber 40 enclosing a confinement apparatus 120, one or more manipulation sources 64 (e.g., 64A, 64B, 64C, 64D, 64E), one or more voltage sources 50, an optics collection system 80, one or more sensors (e.g., calibration sensors and/or the like) and/or the like. In various embodiments, the controller 30 is configured to control the operation of (e.g., control one or more drivers configured to cause operation of) the manipulation sources 64, voltage sources 50, a vacuum system and/or cryogenic cooling system (not shown), and/or the like. In various embodiments, the controller 30 is configured to receive sensor signals (e.g., electrical signals) generated and provided by one or more photodetectors of the optics collection system 80 and/or other sensors of the system.

In an example embodiment, a second substrate 722 may be secured into relationship with the confinement apparatus 720 and house one or more components of the system (e.g., one or more manipulation sources 64E, one or more optical components of a beam path system 66 (e.g., 66A, 66B, 66C), one or more components of the optics collection system 80, one or more sensors, and/or the like).

In an example embodiment, the one or more manipulation sources 64 may comprise one or more lasers (e.g., optical lasers, microwave sources and/or masers, and/or the like) or another manipulation source. In the illustrated embodiment, manipulation sources 64A, 64B, 64C are lasers located outside of the cryogenic and/or vacuum chamber. Manipulation source 64D is a laser, microwave source, or magnetic field or magnetic field gradient source (e.g., permanent magnets, Helmholtz coils, electrical magnets, integrated circuits, and/or the like) that is integrated with the confinement apparatus 720. In an example embodiment, a manipulation source 64E is a laser, microwave source, or magnetic field or magnetic field gradient source (e.g., permanent magnets, Helmholtz coils, electrical magnets, integrated circuits, and/or the like) that is integrated with the second substrate 722.

In various embodiments, the one or more manipulation sources 64 are configured to manipulate and/or cause a controlled quantum state evolution of one or more quantum objects confined by the confinement apparatus 720. In various embodiments, one or more manipulation sources 64 are configured to generate and/or provide one or more manipulation signals configured for performing laser cooling, quantum object initialization and/or state preparation, shelving operations, single qubit gates, two-qubit gates, fluorescence measurement operations, and/or other operations on the quantum objects confined by the confinement apparatus 720. For example, in various embodiments, the manipulation sources 64 include one or more dressing manipulation sources configured to generate and/or provide a first dressing manipulation signal and/or a second dressing manipulation signal to one or more target locations defined at least in part by the confinement apparatus. In various embodiments, the manipulation sources 64 include one or more shelving manipulation sources configured to generate and/or provide a first shelving manipulation signal and/or second shelving manipulation signal.

In various embodiments, the confinement apparatus 720 is an ion trap, such as a surface ion trap, Paul ion trap, and/or the like. In various embodiments, the quantum objects are ions, atoms, molecules, quantum particles, and/or the like.

In an example embodiment, the one or more manipulation sources 64A, 64B, 64C (located outside of the cryogenic and/or vacuum chamber 40) each provide a manipulation signal (e.g., laser beam, microwave signals, and/or the like) to one or more regions and/or target locations 725 of the confinement apparatus 720 via corresponding beam path systems 66 (e.g., 66A, 66B, 66C). In various embodiments, one or more of the beam path systems include an optical assembly 100 (e.g., 100A, 100B) of an example embodiment. In various embodiments, at least one beam path system 66 comprises a modulator configured to modulate the manipulation signal being provided to the confinement apparatus 120 via the beam path system 66. In various embodiments, the manipulation sources 64, active components of the beam path systems 66 (e.g., modulators, etc.), and/or other components of the quantum computer 710 are controlled by the controller 30.

In various embodiments, the quantum computer 710 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes) of the confinement apparatus 120, in an example embodiment. For example, the controller 30 may control operation of the one or more voltage sources 50 to cause the confinement apparatus 720 to confine the quantum object at a target location 725 for performance of various operations thereon. For example, in some embodiments, the controller 30 controls operation of the confinement apparatus 720 by controlling operation of the voltage sources 50 configured to provide respective voltage signals to respective electrodes, for example, of the confinement apparatus 720.

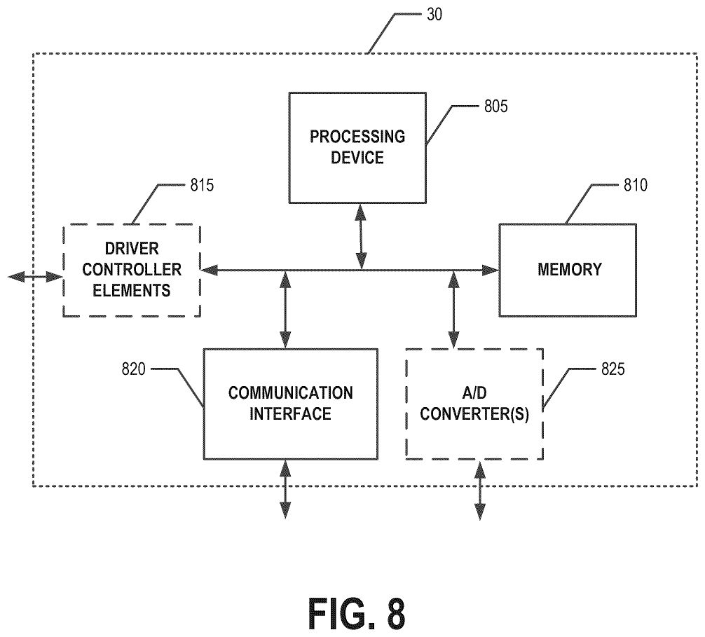

In various embodiments, the quantum computer 710 comprises an optics collection system 80 configured to collect and/or detect photons (e.g., stimulated emission) generated by quantum objects (e.g., during reading procedures). The optics collection system 80 may comprise one or more optical elements (e.g., lenses, mirrors, waveguides, fiber optics cables, splitters/combiners, and/or the like) and one or more sensors, such as photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., quantum objects) of the quantum computer 710. In various embodiments, the sensors (e.g., photodetectors) are in electronic communication with the controller 30 via one or more A/D converters 825 (see FIG. 8) and/or the like.

In various embodiments, the quantum computer may include various other sensors configured for measuring voltage, current, optical power, magnetic fields, and/or the like at various locations within the quantum computer. The sensors may be used to perform image current detection, calibration of voltage signals or manipulation signals, and/or the like.

In various embodiments, a computing entity 15 is configured to allow a user to provide input to the quantum computer 710 (e.g., via a user interface of the computing entity 15) and receive, view, and/or the like output from the quantum computer 710. The computing entity 15 may be in communication with the controller 30 of the quantum computer 710 via one or more wired or wireless networks 20 and/or via direct wired and/or wireless communications. In an example embodiment, the computing entity 15 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the computing entity 15 comprises one or more components similar to those illustrated as part of the computing entity 90 in FIG. 9. For example, the computing entity 15 may include a processing device, (non-transitory) memory (such as volatile memory and/or non-volatile memory), communications interfaces such as one or more network interfaces and/or an antenna in communication with the processing device via a transmitter and/or a receiver), and/or a user interface including input/output devices such as a display and/or keypad.

In various embodiments, the controller 30 is configured to control operation of the voltage sources 50, cryogenic system and/or vacuum system controlling the temperature and pressure within the cryogenic and/or vacuum chamber 40, manipulation sources 64, beam path systems 66, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus, and/or read and/or detect a quantum (e.g., qubit) state of one or more quantum objects confined by the confinement apparatus. In various embodiments, the controller 30 controls operation of the confinement apparatus 720 via controlling operation of the one or more voltage sources 50 to cause desired sequences of voltage signals to be applied to electrodes of the confinement apparatus 720. For example, the controller 30 may cause a controlled evolution of quantum states of one or more quantum objects within the confinement apparatus to execute a quantum circuit and/or algorithm. For example, the controller 30 may control various components of the quantum computer 710 to cause the quantum computer 710 to perform shelving operations, in accordance with example embodiments, on one or more quantum objects confined by the confinement apparatus at one or more points during the execution of a quantum circuit.

### Technical Advantages

Conventional waveplates generally require the incident optical beam to be collimated when the incident optical beam is incident on the waveplate. The collimation of the incident beam results in the angle of incidence of the incident optical beam, with respect to the waveplate, to be consistent across the beam profile. When the incident optical beam is not collimated, conventional waveplates tend to provide only low-fidelity polarization control.

In some instances, such as an array of beams provided via a fiber array or a PIC output array, for example, it may be difficult to provide collimated beams to the waveplate. For conventional waveplates, this may result in polarization purity in the output optical beam that is too low for the intended application. Therefore, technical problems exist regarding providing waveplates that provide high-fidelity polarization control for incident optical beams that are diverging or converging.

Various embodiments provide technical solutions to these technical problems. In various embodiments, at least one property of a waveplate is defined at a plurality of locations across the waveplate. The at least one property at a respective location is determined based at least in part on the expected angle of incidence of an intended incident optical beam. For example, the expected angle of incidence at a respective location on the waveplate of an intended incident optical beam for a particular incident optical beam source is determined and the at least property is determined based on the expected angle of incidence at the respective location.

In some embodiments, the waveplate includes a base material layer that is a birefringent film. The at least one property is a thickness of the birefringent film. For example, the respective thicknesses of the birefringent film at a plurality of locations across the waveplate are determined based on the expected angles of incidence at the plurality of locations.

In some embodiments, the waveplate is a metasurface comprising a plurality of features where each feature is a pillar/protrusion extending from a surface of the base material layer or a hole/recess extending into the surface of the base material layer. A height that a feature extends out from or into the surface of the base material layer, a cross-sectional shape of a feature (in a cross-section taken in a plane parallel to the surface of the base material layer), one or more dimensions of a cross-section (taken in a plane parallel to the surface of the base material layer) of the feature, an orientation of the feature, and/or a position of the feature within a unit cell defined on the waveplate is determined based on an expected angle of incidence at the location of the feature and/or within the unit cell that the feature is disposed within.

In a given optical assembly, an intended incident optical beam source may provide or be configured/designed to provide an expected incident optical beam characterized by a non-zero angle of divergence or convergence. By designing and fabricating the waveplate of the optical assembly to provide an output optical beam having a goal polarization in response to the expected incident optical beam (characterized by the non-zero angle of divergence or convergence) based on the expected angles of incidence of the expected incident optical beam at a plurality of locations across the waveplate, the waveplate is able to have a non-collimated beam incident thereon and provide an output optical beam with high polarization purity. In other words, the non-uniformity of the at least one property of the waveplate at the plurality of locations across the waveplate enables high-fidelity polarization control for an optical assembly without requiring collimation of the incident optical beam.

Such optical assemblies may be included in various systems. For example, such optical assemblies may be part of beam path systems of a quantum and/or atomic system configured to provide optical beams for interaction with confined or trapped quantum and/or atomic objects. For example, the high-fidelity polarization control provided by the optical assembly may enable high-fidelity interactions with quantum and/or atomic objects of a quantum and/or atomic systems such as quantum charge-coupled device (QCCD)-based quantum computers.

Therefore, various embodiments provide technical improvements to technical fields such as waveplates, optical assemblies including waveplates, systems including waveplates, quantum and/or atomic systems where polarization of optical beams used to interact with quantum and/or atomic objects is important, and quantum computers that use optical beams to interact with qubits.

### Example Controller

In various embodiments, an optical assembly 100 is incorporated into a beam path system 66 of a quantum computer 710 or other atomic system. In various embodiments, a quantum computer 710 or other atomic system further comprises a controller 30 configured to control various elements of the quantum computer 710 or other atomic system including one or more optical assemblies 100. For example, the controller 30 may be configured to control the voltage sources 50, a cryogenic system and/or vacuum system controlling the temperature and pressure within the cryogenic and/or vacuum chamber 40, manipulation sources 64 (e.g., 64A, 64B, 64C, 64D, 64E), magnetic field generators, active components of beam path systems 66, and/or other systems controlling the environmental conditions (e.g., temperature, humidity, pressure, and/or the like) within the cryogenic and/or vacuum chamber 40, configured to manipulate and/or cause a controlled evolution of quantum states of one or more quantum objects confined by the confinement apparatus 720, cause the quantum computer 710 to perform a quantum circuit and/or computation, and/or read and/or detect a quantum state of one or more quantum objects confined by the confinement apparatus 720. For example, the controller 30 may be configured to control operation of the confinement apparatus 720 (e.g., via controlling one or more voltage sources 50 configured to provide voltage signals to various potential generating elements/electrodes of the confinement apparatus, in an example embodiment).

As shown in FIG. 8, in various embodiments, the controller 30 may comprise various controller elements including processing device 805, memory 810, driver controller elements 815, a communication interface 820, analog-digital converter elements 825, and/or the like. For example, the processing device 805 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 805 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 810 (e.g., by a processing device 805) causes the controller 30 to perform one or more steps, operations, processes, procedures and/or the like described herein for controlling one or more components of the quantum computer 710 or other atomic system (e.g., voltages sources 50, manipulation sources 64, magnetic field generators, and/or the like) to cause a controlled evolution of quantum states of one or more quantum objects, performing a shelving/deshelving operation, perform quantum circuit and/or quantum computation, detect and/or read the quantum state of one or more quantum objects, and/or the like.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 805). In various embodiments, the driver controller elements 815 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the potential generators (e.g., control electrodes and/or RF electrodes).

In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 825 configured to receive signals from one or more detectors, optical receiver components, calibration sensors, photodetectors of an optics collection system 80, and/or the like.

In various embodiments, the controller 30 may comprise a communication interface 820 for interfacing and/or communicating with a computing entity 15. For example, the controller 30 may comprise a communication interface 820 for receiving executable instructions, command sets, and/or the like from the computing entity 15 and providing output received from the quantum computer 710 (e.g., from an optics collection system 80 comprising one or more photodetectors) and/or the result of a processing the output to the computing entity 15. In various embodiments, the computing entity 15 and the controller 30 may communicate via a direct wired and/or wireless connection and/or one or more wired and/or wireless networks 20.

### Example Computing Entity

FIG. 9 provides an illustrative schematic representative of an example computing entity 90 that can be used in conjunction with embodiments of the present invention. In various embodiments, a computing entity 90 is configured to allow a user to provide input to the quantum computer 710 (e.g., via a user interface of the computing entity 90) and receive, display, analyze, and/or the like output from the quantum computer 710.

As shown in FIG. 9, a computing entity 90 can include an antenna 912, a transmitter 904 (e.g., radio), a receiver 906 (e.g., radio), and a processing device 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a controller 30, other computing entities 90, and/or the like. In this regard, the computing entity 90 may be capable of operating with one or more air interface standards, communication protocols, modulation types, and access types. For example, the computing entity 90 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 90 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 90 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 90 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 90 can also download changes, add-ons, and updates, for instance, to its firmware, software (e.g., including executable instructions, applications, program modules), and operating system. In various embodiments, the computing entity 90 comprises a network interface 920 configured to communicate via one or more wired and/or wireless networks.

In various embodiments, the processing device 908 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 90 may also comprise a user interface device comprising one or more user input/output interfaces (e.g., a display 916 and/or speaker/speaker driver coupled to a processing device 908 and a touch screen, keyboard, mouse, and/or microphone coupled to a processing device 908). For instance, the user output interface may be configured to provide an application, browser, user interface, interface, dashboard, screen, webpage, page, and/or similar words used herein interchangeably executing on and/or accessible via the computing entity 90 to cause display or audible presentation of information/data and for interaction therewith via one or more user input interfaces. The user input interface can comprise any of a number of devices allowing the computing entity 90 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 90 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 90 can collect information/data, user interaction/input, and/or the like.

The computing entity 90 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 90.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A waveplate comprising:
one or more base material layers,
wherein the waveplate is characterized by at least one property,
wherein the at least one property is location dependent such that the at least one property is non-uniform across the waveplate, and
wherein the waveplate is configured to modify or control a polarization of an optical beam that interacts with the waveplate via the at least one property.

2. The waveplate of claim 1, wherein the one or more base material layers comprise a birefringent film and the at least one property is a thickness of the birefringent film.

3. The waveplate of claim 2, wherein the thickness of the birefringent film varies smoothly across the waveplate.

4. The waveplate of claim 1, wherein the waveplate further comprises one or more features, the one or more features comprise at least one of (i) a protrusion extending out from a surface of the one or more base material layers or (ii) a recess extending into the surface of the one or more base material layers, and the at least one property is at least one of (a) at least one dimension of the feature, (b) a shape of the feature, (c) an orientation of the feature, or (d) a position of the feature.

5. The waveplate of claim 1, wherein a plurality of unit cells are defined across a surface of the one or more base material layers, the waveplate further comprises a plurality of features disposed at respective locations within respective unit cells of the plurality of unit cells, each feature of the plurality of features is one of a protrusion extending out from the surface of the one or more base material layers or a recess extending into the surface of the one or more base material layers, and the at least one property is at least one of (a) respective dimensions of the plurality of features, (b) respective shapes of the plurality of features, (c) respective orientations of the plurality of features, or (d) positions of the respective locations of the plurality of features within the respective unit cells.

6. The waveplate of claim 1, wherein the location dependence of the at least one property corresponds to or is defined by respective expected angles of incidence of the optical beam interacting with the waveplate.

7. An optical assembly comprising:
an incident optical beam source configured to provide one or more incident optical beams for interacting with a waveplate; and
the waveplate configured to provide one or more respective output optical beams each characterized by a respective goal output polarization in response to an incident optical beam of the one or more incident optical beams interacting with the waveplate, wherein the waveplate comprises:
one or more base material layers,
wherein the waveplate is characterized by at least one property,
wherein the at least one property is location dependent such that the at least one property is non-uniform across the waveplate, and
wherein the at least one property affects a polarization of the respective output optical beam.

8. The optical assembly of claim 7, wherein the one or more base material layers comprises a birefringent film and the at least one property is a thickness of the birefringent film.

9. The optical assembly of claim 8, wherein the thickness of the birefringent film varies smoothly across the one or more base material layers.

10. The optical assembly of claim 7, wherein the waveplate further comprises one or more features, each of the one or more features is a respective one of a (i) protrusion extending out from a surface of the one or more base material layers or (ii) a recess extending into the surface of the one or more base material layers, and the at least one property is at least one of (a) at least one dimension the feature, (b) a shape of the feature, (c) an orientation of the feature, or (d) a position of the feature.

11. The optical assembly of claim 7, wherein a plurality of unit cells are defined across the one or more base material layers, the waveplate further comprises a plurality of features disposed at respective locations within respective unit cells of the plurality of unit cells, each feature of the plurality of features is one of a protrusion extending out from a surface of the one or more base material layers or a recess extending into the surface of the one or more base material layers, and the at least one property is at least one of (a) respective dimensions of the plurality of features, (b) respective shapes of the plurality of features, (c) respective orientations of the plurality of features, or (d) respective positions of the respective locations of the plurality of features within the respective unit cells.

12. The optical assembly of claim 7, wherein the location dependence of the at least one property corresponds to or is defined by respective expected angles of incidence of an optical beam interacting with the waveplate.

13. The optical assembly of claim 12, wherein the incident optical beam source is configured to provide the one or more incident optical beams such that the one or more incident optical beams are characterized by an expected angle of divergence or convergence and the incident optical beam source and the waveplate are secured with respect to one another such that the incident optical beam source and the waveplate are separated by an set distance, and the respective expected angles of incidence at respective locations across the waveplate are determined based at least in part on the expected angle of divergence or convergence and the set distance.

14. The optical assembly of claim 12, wherein the optical assembly is part of a beam path system of a quantum or atomic system.

15. A quantum or atomic system comprising:
a confinement apparatus defining at least one target location and configured to confine one or more quantum or atomic objects; and
one or more beam path systems, at least one of the one or more beam path systems comprising an optical assembly configured to provide a respective output optical beam to the at least one target location for interaction with at least one of the one or more quantum or atomic objects confined at the target location,
wherein the optical assembly comprises a waveplate comprising one or more base material layers, wherein the waveplate is characterized by at least one property and the at least one property is location dependent such that the at least one property is non-uniform across the waveplate, and the at least one property affects a polarization of the respective output optical beam.

16. The quantum or atomic system of claim 15, wherein waveplate comprises one or more base material layers and the one or more base material layers comprises a birefringent film and the at least one property is a thickness of the birefringent film.

17. The quantum or atomic system of claim 15, wherein the waveplate further comprises one or more features, each feature of the one or more features is a respective one of a (i) protrusion extending out from a surface of one or more base material layers of the waveplate or (ii) a recess extending into the surface of the one or more base material layers, and the at least one property is at least one of (a) at least one dimension the feature, (b) a shape of the feature, (c) an orientation of the feature, or (d) a position of the feature.

18. The quantum or atomic system of claim 15, wherein a plurality of unit cells are defined across the one or more base material layers, the waveplate further comprises a plurality of features disposed at respective locations within respective unit cells of the plurality of unit cells, each feature of the plurality of features is one of a protrusion extending out from a surface of the one or more base material layers or a recess extending into the surface of the one or more base material layers, and the at least one property is at least one of (a) respective dimensions of the plurality of features, (b) respective shapes of the plurality of features, (c) respective orientations of the plurality of features, or (d) respective positions of the respective locations of the plurality of features within the respective unit cells.

19. The quantum or atomic system of claim 15, wherein the location dependence of the at least one property corresponds to or is defined by respective expected angles of incidence of an optical beam interacting with the waveplate.

20. The quantum or atomic system of claim 19, wherein the at least one of the one or more beam path systems comprises an incident optical beam source that is configured to provide the one or more incident optical beams such that the one or more incident optical beams are characterized by an expected angle of divergence or convergence and the incident optical beam source and the waveplate are secured with respect to one another such that the incident optical beam source and the waveplate are separated by an set distance, and the respective expected angles of incidence at respective locations across the waveplate are determined based at least in part on the expected angle of divergence or convergence and the set distance.
